(19) United States
(12) Patent Application Publication
(10) Pub. No.: US 2026/0311582 A1
(43) Pub. Date: Oct. 8, 2026

(54) Perimeter Subarea Supervisor System (PSSS)

(71) Applicant: Ramon Vladimir Rodriguez Delfin, Hialeah, FL (US)

(72) Inventor: Ramon Vladimir Rodriguez Delfin, Hialeah, FL (US)

(21) Appl. No.: 19/169,008

(22) Filed: Apr. 3, 2025

(51) Int. Cl. G08B 21/02; G08B 29/18; H04W 4/021

(52) U.S. Cl. CPC G08B 21/02; G08B 29/185; H04W 4/021

(57) ABSTRACT

The Perimeter Subarea Supervisor System (PSSS) enables advanced monitoring of sensitive areas by creating a global map where, through precise calibration, one or more perimeters can be selected within the global area. Each perimeter can be subdivided into hierarchical subareas (alert, warning, and core), with each activating specific and progressive alarms based on their priority and proximity to the protected area, ensuring clear and relevant responses. The system uses a Scanner that can operate autonomously when full visibility is available. If there are obstacles or visibility limitations, the system can incorporate multiple scanners to ensure complete coverage. Its versatile and modular design allows it to be configured for various environments, offering connectivity with mobile devices and the cloud for remote monitoring and advanced functionality. The PSSS combines precision, flexibility, and scalability, making it ideal for applications in risk zones, pool areas, and other critical environments requiring reliable control.

### BACKGROUND

Accidents in sensitive areas, such as patios with swimming pools or high-risk zones, represent a significant problem, especially for children, elderly people, and pets. Traditional monitoring systems often generate false alarms due to their inability to distinguish relevant events, such as human movements, from minor disturbances caused by objects or environmental conditions. This reduces their effectiveness and may lead users to discontinue their use.

The Perimeter Subarea Supervisor System (PSSS) emerges as an innovative solution for the protection and monitoring of specific areas in sensitive environments, such as patios with swimming pools or high-risk zones. This system employs advanced mapping technology to create a precise model of the environment and efficiently delineate protected zones.

Comprised of a Scanner and a Portable Station, the PSSS allows for both automatic and manual calibrations, ensuring precision in the delimitation of perimeters and hierarchical subareas. These subareas (alert, warning, and core) are designed to activate visual and audible alarms progressively, responding only to specific trajectories registered within predefined coordinates. This approach reduces false alarms and ensures notifications are clear and relevant.

The Portable Station, in addition to serving as the main control component, manages alarms and facilitates system configuration through an intuitive interface. Meanwhile, the Scanner continuously evaluates distances and movements within the coordinates established during calibration, focusing exclusively on relevant events.

The PSSS offers a unique combination of precision, adaptability, and ease of use, making it an indispensable tool for the effective supervision of critical areas.

### DESCRIPTION

The Perimeter Subarea Supervisor System (PSSS) consists of two main components: a Scanner and a Portable Station.

Scanner: This device is the core of the PSSS, designed to perform detailed mapping of the environment by accurately capturing structural features such as edges, obstacles, columns, and fences. Using advanced emission and reception technology, the Scanner generates a three-dimensional model of the global area, establishing coordinates that serve as a foundation for subsequent configurations. Additionally, it includes visual and audible alarm systems that activate progressively based on specific trajectories detected in the configured hierarchical subareas.

Portable Station: This component acts as the control center of the system, providing the user with an intuitive interface to manage essential functions. The Portable Station allows the execution of global and perimeter calibrations, monitoring alarms, and controlling the system's general parameters. Through direct commands to the Scanner, it facilitates the creation of detailed maps, perimeter delimitation, and customization of subareas.

The system operates through two main types of calibration:
1. Global Calibration: This is the initial step to map the entire environment. The operator uses the Portable Station to activate this function, ensuring that the area is clear. During this phase, the Scanner performs a detailed sweep, generating a three-dimensional map of the global area and registering key coordinates such as boundaries, obstacles, and significant structures.
2. Perimeter Calibration: Once the global map is generated, the user can select one or more specific perimeters within the mapped area. This process begins at the edge of the area to be protected, where the operator activates the perimeter calibration function and physically walks the perimeter counterclockwise with the Portable Station in hand. Upon completion, the system automatically closes the perimeter, or the user can manually define the closure.

Once the perimeter is delimited, the system automatically subdivides it into three hierarchical subareas:
a. Alert Subarea: Detects movements approaching the protected area.
b. Warning Subarea: Monitors movements near the protected core, providing an early warning.
c. Core Subarea: Focuses on critical high-risk areas, activating alarms of greater intensity.

Additionally, the system offers an optional personalized calibration to adjust the boundaries of the suburban areas according to the specific needs of the environment, providing flexibility and precision in the configuration.

The visual and audible alarms work progressively, evaluating trajectories detected within the configured coordinates. The system minimizes false alarms by responding only to movements that have previously crossed the earlier subareas, ignoring irrelevant disturbances.

The PSSS is a versatile system that can operate with a single Scanner in areas with full visibility or integrate multiple Scanners to cover zones with visual obstacles. It is compatible with mobile applications and can connect to the cloud for remote access and advanced control.

Thanks to its modular design and adaptability, the PSSS is a robust and efficient tool for the hierarchical protection and supervision of critical areas.

These and other features of the invention will be better understood with the help of the following drawings:

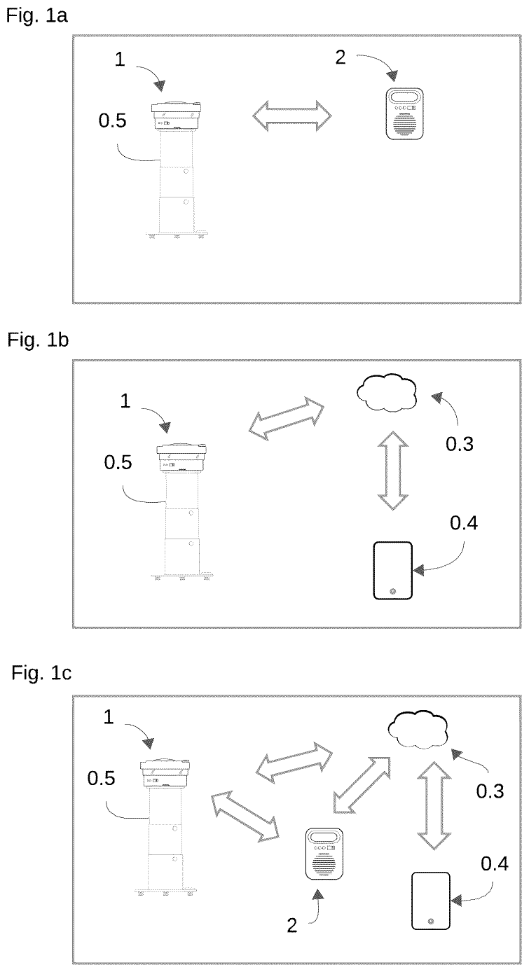

FIG. 1a: A frontal lateral view of the invention showing the direct interaction between the components.

FIG. 1b: A representation including the connection of the invention with a cloud-based system.

FIG. 1c: A view illustrating the complete interaction of the connected elements.

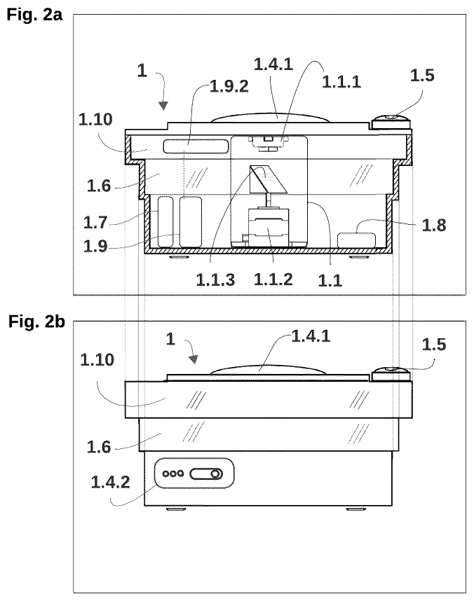

FIG. 2a: A detailed internal view of the main elements of the Scanner.

FIG. 2b: An external view of the Scanner showing its visible characteristics.

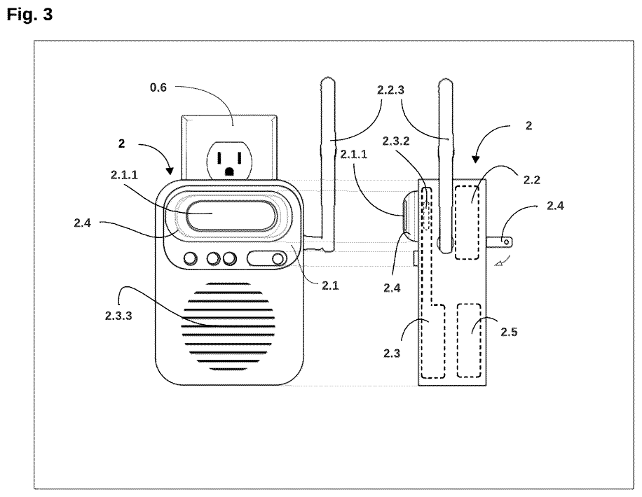

FIG. 3: A view of the portable station highlighting its internal and external components.

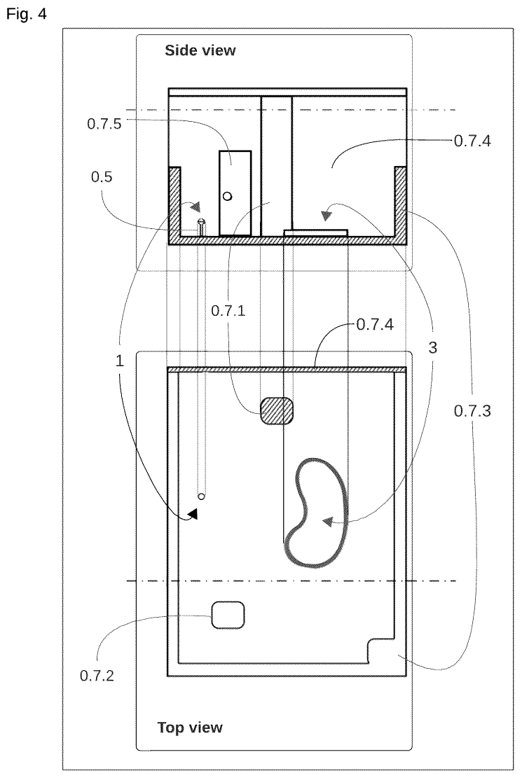

FIG. 4: A top view (plan view) and a side view of a global area representing a patio with a swimming pool.

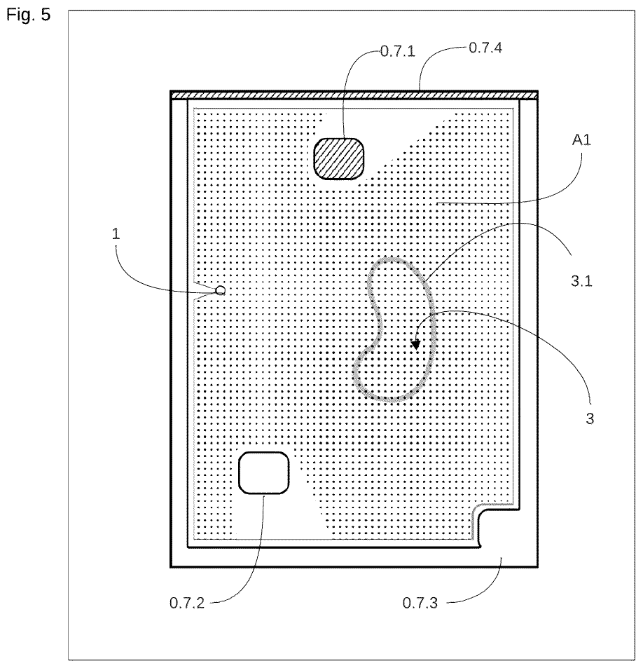

FIG. 5: Top view (plan view) of a global area with a swimming pool, highlighting the dotted area that represents the scanned zone during the global calibration.

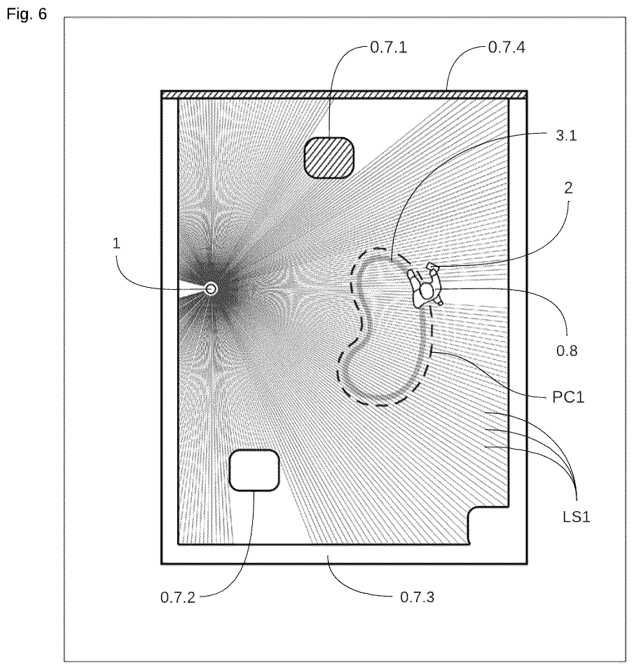

FIG. 6: Top view (plan view) of a global area with a swimming pool, showing a subject walking around the edge of the pool during the perimeter calibration process.

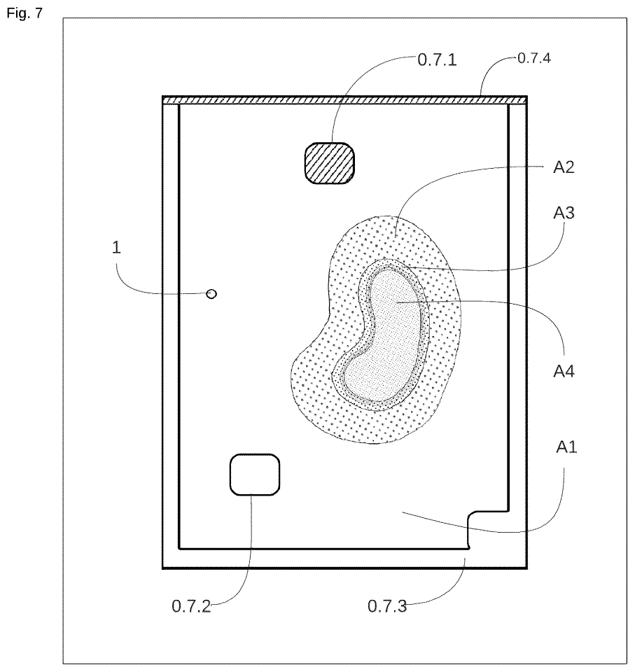

FIG. 7: Top view (plan view) of a global area with a swimming pool, highlighting the subdivision into hierarchical areas after the calibration process.

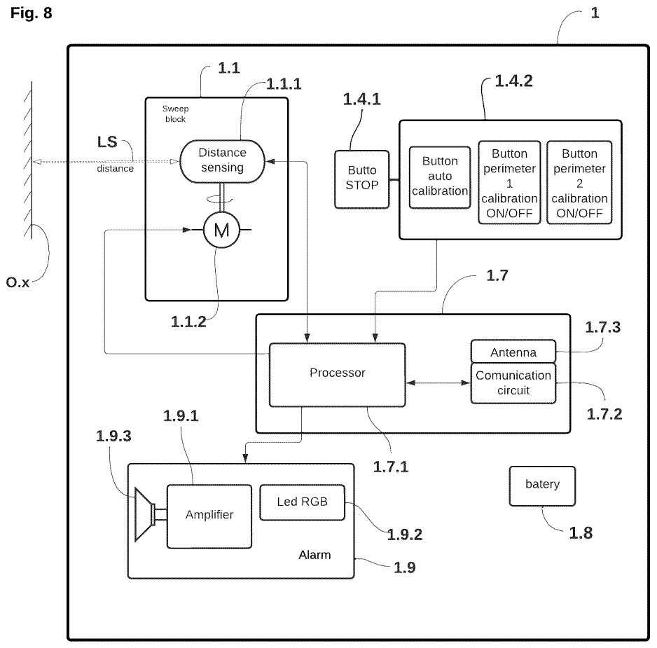

FIG. 8: Block diagram of the Scanner device.

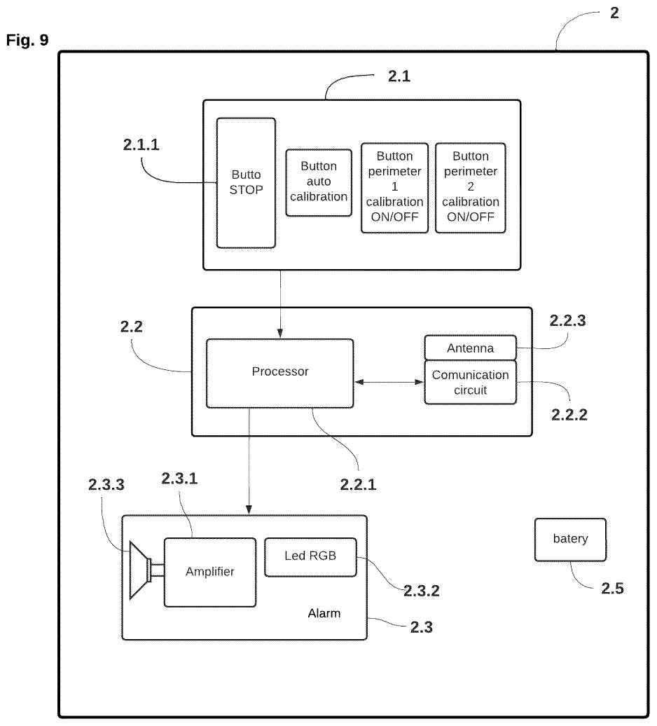

FIG. 9: Block diagram of the Portable Station device.

The Perimeter Subarea Supervisor System (PSSS) operates primarily with a Scanner 1 on an adjustable base 0.5 and a Portable Station 2, as shown in FIG. 1a. In this configuration, Scanner 1 and Portable Station 2 communicate directly via a bidirectional link, allowing the system to operate without requiring an Internet connection. Although this is the most basic and common mode of operation, the system can also connect through the Internet, using cloud 0.3 as an intermediary, as illustrated in FIGS. 1b and 1c. In FIG. 1b, Portable Station 2 is replaced by a Mobile Application. Scanner 1 communicates directly with cloud 0.3, which in turn sends information to mobile devices 0.4. This allows the system's data to be accessed remotely, expanding the possibilities for supervision and control from any location. Additionally, the configuration shown in FIG. 1c demonstrates complete interaction between the three main system components: Scanner 1, Portable Station 2, and cloud 0.3. This approach enables Portable Station 2 and mobile devices 0.4 to interact both with Scanner 1 and with each other, offering an integrated and flexible system for various applications.

In FIG. 2a, a sectional view of Scanner 1 is shown, highlighting its internal components. It includes the alarm stop button 1.4.1, the scanning system 1.1, which is the main component or accessory of the system, consisting of the distance sensor 1.1.1, rotating mirror 1.1.3, and motor 1.1.2, which enable precise scanning of the environment. The backup battery 1.8 ensures system operation when the power supply is interrupted. The RGB LEDs 1.9.2 provide illumination for visual alarms, forming part of the alarm system 1.9, which also integrates the amplifier 1.9.1 and speaker 1.9.3 for audible alarms. Additionally, the output screen 1.6 contains a filter that blocks ultraviolet light for enhanced safety during use. ###The transparent casing 1.10 allows clear visualization of the lighting generated by the visual alarms.

FIG. 2b shows an external view of Scanner 1, displaying its accessible elements for system operation. It highlights the alarm stop button 1.4.1, located in the main control panel 1.4.2, designed to allow intuitive handling. The output screen 1.6 allows the emission of the beam used in scanning while protecting the emitting system from the external environment, and the lighting screen 1.10 makes visible the signals of visual alarms generated by the RGB LEDs. These combined elements ensure efficient and clear interaction between the user and Scanner 1.

Portable Station 2 is shown in FIG. 3, highlighting both its front and side views, along with its internal and external components. In the front view, the control buttons 2.1 can be seen, including the stop button 2.1.1, designed to immediately stop the alarms. Also visible is the lighting screen 2.4, which provides clear visual indications, and the audio output 2.3.3, through which the system's audible signals are emitted.

In the side view, the internal elements of the Portable Station are represented. It includes the antenna 2.2.3, responsible for wireless communication, and the communication circuit 2.2, which ensures efficient data transmission and reception. The station includes an alarm circuit 2.3, which manages both audible and visual alarms. Additionally, the battery 2.5 ensures continuous operation in case of power supply interruptions.

At the top, there is the socket 0.6, which allows the Portable Station to be connected to the electrical current for primary power. Additionally, the retractable pins 2.4 complement the device's functionality by offering a versatile and secure connection.

FIG. 4 represents an architectural layout of the pool area, showing both a top view (top view) and a side view (side view). The side view highlights a cross-section that allows observing internal details of the structures, while the top view offers a complete perspective of space distribution.

In the side view, the external access to the patio is identified by door 0.7.5, located on a dividing wall 0.7.4 that separates the house from the pool area. Column 0.7.1, which extends to the ceiling, is a relevant structural element in this area.

In the top view, the patio is detailed with pool 3 and its surrounding elements. Scanner 1 is strategically placed for area monitoring. The perimeter wall or fence 0.7.3 defines the zone, while the dividing wall 0.7.4 provides a boundary between the internal and external spaces. Additionally, a generic object 0.7.2 is included, representing any element that might be in the area, such as a column, table, or tree.

This design demonstrates how the system integrates into an architectural environment, ensuring adequate coverage of the supervised area.

A top view of the scanned global area is represented in FIG. 5, where Scanner 1 is strategically positioned to perform the mapping of the environment. The dotted area A1 corresponds to the zone mapped after the global calibration of the system.

The pool is represented by number 3, while its physical edge is identified as 3.1. The perimeter wall or fence 0.7.3 defines the supervised zone, and the dividing wall 0.7.4 separates the exterior area from the interior. Additionally, the generic object 0.7.2 can represent any element found in the environment, such as a column or tree.

This scheme highlights how the system performs a detailed mapping of the global area, because of the initial or global calibration, establishing a basis for further configurations and calibrations.

In FIG. 6, the Scanner 1 is shown, used to perform the mapping and scanning of the area, while the subject or operator 0.8 walks near the physical edge of the pool 3.1 counterclockwise, holding in their hand the Portable Station 2, used as a remote control to activate the Scanner 1, performs the perimeter scan delimiting or marking the physical edge 3.1 or scanned perimeter.

This is possible due to the differences between the laser distance lines LS1 (in case of using LIDAR system) from the global scan to the perimeter one. The figure also shows the column 0.7.1 represented as a fixed structure reaching the ceiling, the dividing wall 0.7.4, and the wall or fence 0.7.3, which establish the limits of the scanned area. The object 0.7.2 is a generic element present in the global area, and the pool is marked with the number 3.

In FIG. 7, Scanner 1, a column represented as 0.7.1, the external limit defined by the dividing wall 0.7.4, the wall or fence 0.7.3, and any object represented as 0.7.2 are observed. The delimited areas are presented.

After the perimeter calibration or calibrations, the global area A1 is subdivided into specific hierarchical subareas as shown in FIG. 7, where A2 is the alert area, designed to detect external approaches to the scanned perimeter; A3 is the warning area, intended to notify movements near the protected core; and A4 is the core area, which requires immediate attention to any event.

Although the global area A1 is initially defined, it is excluded from the active system once the specific delimitations of the subareas are completed.

However, it can be included as an active hierarchical zone if the system user desires, offering flexibility in the system configuration.

The alarms are activated progressively, ensuring that each subarea only responds if the previous areas have been activated and within the nearby coordinates. This avoids inconvenient false alarms.

FIG. 8 shows a block diagram of Scanner 1, designed to perform environmental scanning and ensure the precise detection of events. The system operates by emitting LS signals, which are reflected by environmental elements such as columns, fences, walls, or subjects, generically represented as 0.X, and sent to the distance sensor 1.1.1. The sensor forwards this information to processor 1.7, which collects the necessary data to determine the area coordinates.

The central processor 1.7 receives sensor data, interprets the distances, and compares them with the information stored during the initial calibration process. If it detects a discrepancy or relevant event, such as an unidentified object or a change in the area's configuration, the processor activates the alarms through block 1.9, composed of: 1.9.1: An amplifier to generate acoustic signals, 1.9.2: RGB LEDs for visual alarms, 1.9.3: Speakers to emit audible alerts.

The device also includes a communication circuit 1.7.2 and an antenna 1.7.3, which allows alarm notifications to be sent to external devices such as portable stations or connected mobile applications.

The operation of Scanner 1 is controlled via the control panel 1.4, which includes: 1.4.1: Alarm stop button, 1.4.2: Buttons to activate and deactivate automatic and perimeter calibrations.

The system is powered by a backup battery 1.8, ensuring continuous operation in case of power supply interruptions. The integration of all these components allows Scanner 1 to operate efficiently and ensure the safety of the monitored area.

The operation of the Portable Station 2 is illustrated in FIG. 9, which coordinates the monitoring system's operations. The process begins with the user interaction through the main control panel 2.1, which includes options to stop alarms (2.1.1), perform automatic calibrations, and configure specific perimeters. These signals are processed by the system's core, the processor 2.2, responsible for interpreting commands and distributing them to the corresponding blocks.

The processor communicates through communication circuit 2.2.1, using the antenna 2.2.3, which establishes wireless connections with other system components, such as Scanner 1 and mobile devices.

Alarms are managed by block 2.3, which combines: 2.3.1: An amplifier, 2.3.2: RGB LEDs for visual signals, 2.3.3: A speaker for audible alerts.

These alarms are triggered based on processed data, indicating risk situations according to the established configurations.

The battery 2.5 ensures the operability of the Portable Station even in the event of power supply loss, providing autonomy and continuity to the system.

As a whole, the Portable Station 2 serves as the control center for all operations, integrating the functions of calibration, communication, and alarm management into a compact and efficient device.

The Perimeter Subarea Supervisor System (PSSS) is an advanced preventive system that allows risks to be identified before they occur. It can select specific areas within a global environment and subdivide them into three hierarchical subareas (alert, warning, and core) for precise monitoring. Additionally, it minimizes false alarms through a stepped activation scheme that ensures clear and relevant responses only to critical events.

The implementations of the PSSS described in this document are exemplary, and numerous modifications, combinations, variations, and reorganizations can be foreseen to achieve an equivalent result, all of which are intended to be included within the scope of the attached claims. Furthermore, nothing presented herein about the PSSS should be interpreted as limiting the invention to a specific configuration or a combination of implementations. The scope of the invention is defined by the description, the drawings, and the attached claims.

1. A perimeter subarea supervisor system (PSSS) comprising a scanning device configured to generate an environmental map through automatic calibration, a manual calibration function for defining a user-customizable perimeter within the global area, and a subdivision mechanism that separates the perimeter into hierarchical zones to classify levels of threat and activate corresponding alarms.

2. The system of claim 1, wherein the scanning device is designed to generate a map of the environment through an initial automatic calibration that defines a global area.

3. The system of claim 1, wherein the manual calibration function delineates a specific perimeter within the global area, allowing adjustment and redefinition of the limits.

4. The system of claim 1, wherein the subdivision mechanism divides the perimeter into three hierarchical areas including an alert area to detect approach, a warning area to monitor threat proximity, and an alarm area that activates an immediate response.

5. The system of claim 1, wherein the scanning device enables both automatic and manual calibration, allowing the perimeter to be redefined as needed.

6. The system of claim 1, wherein the three hierarchical areas are dynamically adjustable and can be configured according to specific environmental risk levels or operational criteria.

7. The system of claim 1, wherein visual and audible alarms are triggered based on the trajectory of detected movements crossing one or more subareas.

8. The system of claim 1, wherein the components communicate with a portable station that enables configuration, monitoring, and control of the entire security operation.

9. The system of claim 1, wherein the perimeter definition is stored in memory and can be modified remotely through a secure interface.

10. The system of claim 1, wherein the portable station provides real-time visual feedback of detected movements and allows manual override of the alarm zones.

11. The system of claim 1, wherein wireless communication between components is established through technologies such as radio frequency or Bluetooth, without requiring internet connectivity, while optionally allowing integration with mobile applications or cloud-based services.

12. The system of claim 1, wherein the system is designed to operate in conjunction with a remote application or networked interface and alternatively includes a standalone operating mode using a base receiver without relying on internet connectivity.

13. The system of claim 1, wherein the activation of alarms is based on sequential logic requiring the progressive crossing of defined subareas in a predetermined order to reduce false alarms.

14. The system of claim 13, wherein the sequential logic is optionally configurable to allow non-sequential triggering of alarm zones for specific scenarios.
